(19) United States
(12) Patent Application Publication
(10) Pub. No.: US 2005/0271423 A1
(43) Pub. Date: Dec. 8, 2005

(54) Wet type image forming apparatus

(75) Inventors: Hidetaka Yamaguchi, Tokyo (JP); Motohiro Maseki, Saitama-ken (JP); Hiroyuki Saito, Tokyo (JP); Masatoshi Takano, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/137,576

(22) Filed: May 26, 2005

(30) Foreign Application Priority Data
Jun. 7, 2004 (JP) 2004-167975

(51) Int. Cl. G03G 15/10

(52) U.S. Cl. 399/237

(57) ABSTRACT

A wet type electrophotographic image forming apparatus using a developing solution containing a toner in a carrier solution is provided with a photoconductive drum on which a latent image is formed, a developing solution applying roller that applies the developing solution to a surface of the photoconductive drum, and a developing solution reservoir in which the developing solution is deposited. Further, a part of a surface of the developing solution applying roller serves as a wall portion defining the reservoir, and a bottom surface of the reservoir serves as a blade member that contacts a surface of the developing solution applying roller to scrape off and adjust the developing solution on the surface of the developing solution applying roller.

### BACKGROUND OF THE INVENTION

The present invention relates to a wet type image forming apparatus that forms an image with a developing solution containing a toner in a carrier solution.

Apparatuses that transfer a toner to a recording paper to thereby form an image include, for example, a dry type image forming apparatus, which applies a powder toner to a surface of a developing roller to form an image, and a wet type image forming apparatus, which applies a developing solution containing a toner in a carrier solution to a surface of a developing roller to form an image, as disclosed in Japanese Patent Provisional Publication No. P2002-278300A. The toner employed in the latter apparatus is finer than that employed in the former. Accordingly, the latter provides an image of a higher quality.

The wet type image forming apparatus disclosed in the above publication includes a roller (referred to as a “patterned roller” in the publication) for uniformly applying a developing solution to a surface of a developing roller. The patterned roller is provided with fine grooves formed at every predetermined interval on its surface. The developing solution is retained only in the grooves, so that an appropriate amount of developing solution is uniformly applied to the developing roller surface. The developing solution that has adhered to a portion except the grooves is removed by a blade disposed in contact with the surface of the patterned roller to adjust the amount of the developing solution retained in the grooves. Accordingly, the patterned roller effectively serves to significantly reduce uneven development, thus to provide a printout of a high-resolution image on a recording paper.

However, in the foregoing wet type image forming apparatus, the developing solution is supplied to the patterned roller only for a short time, in other words not a sufficient portion of the surface area of the patterned roller is dipped in the developing solution, which impedes the developing solution from completely filling the grooves on the patterned roller. This naturally leads to inadequate supply of the developing solution to the developing roller, which often results in uneven development. Besides, this wet type image forming apparatus includes a toner supply tray as an indispensable constituent, for supplying the developing solution to the patterned roller. This is a significant disadvantage when attempting to make the apparatus more compact.

### SUMMARY OF THE INVENTION

The present invention is advantageous in that an improved wet type image forming apparatus can be provided. The improved apparatus is capable of sufficiently supplying a developing solution to a patterned roller. Further, the improved wet type image forming apparatus can be built with smaller dimensions.

According to aspects of the invention, there is provided a wet type image forming apparatus using a developing solution containing a toner in a carrier solution. The apparatus includes a photoconductive drum on which a latent image is formed, a developing solution applying roller that applies the developing solution to a surface of the photoconductive drum, and a blade unit having a blade member disposed in contact with a surface of the developing solution applying roller, the blade scraping off and adjusting the developing solution on the surface of the developing solution applying roller, and a wall portion connected to the blade member such that the blade member, the wall portion and a part of the surface of the developing solution applying roller define a reservoir in which the developing solution is deposited.

Optionally, the wet type image forming apparatus may further include a developing solution collecting tank in which the developing solution that has been applied on at least one of the developing solution applying roller and the photoconductive drum but has not been consumed is stored, and a developing solution supplier that supplies the developing solution in the developing solution collecting tank to the reservoir.

Further optionally, the developing solution supplier may include a frame including a first opening located in the collection tank developing solution and a second opening located close to the reservoir, a spiral rotor installed inside the frame, which rotates to forward a fluid entering through the first opening to the second opening, and a driver that causes the spiral rotor to rotate.

Still optionally, the developing solution applying roller and the blade member may be in mutual contact at a position lower than a central portion of the developing solution applying roller.

Further, the developing solution applying roller and the blade member may be in mutual contact at a position close to the interface between the developing solution applying roller and the toner supplier.

Furthermore, the blade member may be formed such that an uppermost portion thereof is located lower than an uppermost portion of the developing solution applying roller.

According to further aspects of the invention, there is provided a wet type electrophotographic image forming apparatus using a developing solution containing a toner in a carrier solution. The apparatus is provided with a photoconductive drum on which a latent image is formed, a developing solution applying roller that applies the developing solution to a surface of the photoconductive drum, and a developing solution reservoir in which the developing solution is deposited. Further, a part of a surface of the developing solution applying roller serves as a wall portion defining the reservoir, and a bottom surface of the reservoir serves as a blade member that contacts a surface of the developing solution applying roller to scrape off and adjust the developing solution on the surface of the developing solution applying roller.

### BRIEF DESCRIPTION OF THE ACCOMPANYING DRAWINGS

FIG. 1 is a cross-sectional side view showing a structure of a wet type printer according to an embodiment of the present invention;

FIG. 2 is cross-sectional side view showing a section around a developing solution applicator of the wet type printer of FIG. 1; and

FIG. 3 is a plan view from an upper direction showing a section around a developing solution applicator of the wet type printer of FIG. 1.

### DETAILED DESCRIPTION OF THE EMBODIMENT

Referring to the accompanying drawings, a wet type printer according to an embodiment of the present invention will be described in detail.

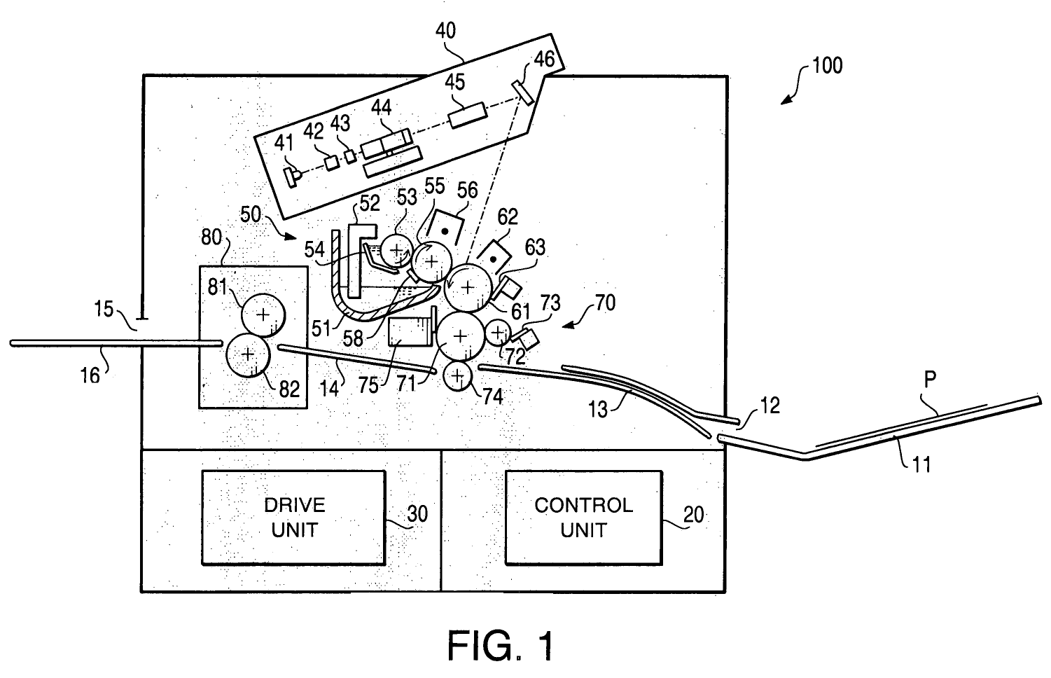

FIG. 1 is a cross-sectional side view showing a structure of a wet type printer 100 according to an embodiment of the present invention. The wet type printer 100 is an apparatus that forms an image with a developing roller that carries, on its surface, a developing solution containing a toner in a carrier solution, and more specifically an apparatus that receives print information (i.e., character and/or image information) from an external apparatus such as a computer, and prints out the letter or image on a recording paper P in accordance with a so-called electrophotographic imaging process.

The wet type printer 100 generally includes a control unit 20 that controls a printing process, sheet feeding operation and so on, a driving unit 30 that drives various mechanisms, a laser scanning unit (hereinafter, abbreviated as “LSU”) 40 that outputs a laser beam modulated according to print information, a developing unit 50 that develops a latent image formed according to print information with a developing solution, a transfer unit 70 that transfers a toner image developed by the developing unit 50 at a transfer position onto the recording paper P, a feeding mechanism that feeds the recording paper P, and a fixing unit 80 that permanently fixes the toner image which has been transferred on the recording paper P.

The driving unit 30 serving as a driving source of the mechanisms in the wet type printer 100 includes a plurality of actuators that drive the respective mechanisms. All of these actuators are connected to the control unit 20, to be driven under the control of the control unit 20. The driving unit 30 can cause a rotation of, for example, a developing roller 55 and photoconductive drum 61 included in the developing unit 50, and a heat roller 81 included in the fixing unit 80.

On a side face of a housing of the wet type printer 100, a paper inlet 12 is formed, through which the recording paper P is introduced into the printer 100, and a paper tray 11 for storing the recording paper P is attached at the paper inlet 12. On the opposite side face of the housing, a paper outlet 15 and a receiver tray 16 are provided. The recording paper P, upon being introduced into the wet type printer 100 through the paper inlet 12, is fed along a paper path 13 to reach the transfer position defined by the transfer unit 70, where the toner image is transferred onto the surface of the recording paper P. Thereafter the recording paper P is fed along a paper path 14 to reach a fixing position defined by the fixing unit 80 for fixation of the toner image. Then, the recording paper P is discharged from the wet type printer 100 through the paper outlet 15.

The toner image corresponding to the print information to be transferred to the recording paper P at the transfer unit 70 is initially generated by the control unit 20 and the LSU 40. The LSU 40 includes a laser diode 41 serving as a light source, a collimating lens 42, a cylindrical lens 43, a polygon mirror 44, an imaging lens 45 and a deflecting mirror 46. Instead of the LSU 40, an LED (Light Emitting Diode) and a reducing optical system may be employed as the exposure method.

The laser diode 41 is driven under the control of the control unit 20. That is, the laser diode 41 is turned on and off (i.e. modulated) according to the print information, thereby emitting a laser beam modulated carrying the image information. The laser beam irradiated by the laser diode 41 enters the collimating lens 42, which converts the laser beam from a diffused luminous flux into a parallel luminous flux.

The laser beam converted into a parallel luminous flux (i.e., collimated) is converged by the cylindrical lens 43 solely in a sub-scanning direction so that the laser beam is converged on a plane, in the sub-scanning direction, close to a reflecting surface of the polygon mirror 44. It is to be noted that the sub-scanning direction herein referred to designates a direction parallel to a plane of FIG. 1 (a direction orthogonal to the rotating shaft of the photoconductive drum 61, i.e. a tangent on a circumferential surface thereof), while a direction orthogonal to the sub-scanning direction, i.e. a direction in which the laser beam is scanned on the photoconductive drum 61 (an axial direction on the photoconductive drum 61) is herein defined as a main scanning direction.

The polygon mirror 44 is rotated by a motor (not shown), and hence the laser beam linearly converged (converged only in a sub-scanning direction) by the cylindrical lens 43 substantially at a section of the reflecting surface of the polygon mirror 44 is deflected so as to be scanned in a main scanning direction, and enters the imaging lens 45. The laser beam passed through the image forming lens 45 scans in a main scanning direction at a predetermined speed on the photoconductive drum 61. The laser beam thus converted is deflected by the deflecting mirror 46 toward the photoconductive drum 61, to thereby form an image on the photoconductive drum 61. At this stage, since the laser beam is modulated with the progress of the main scanning, a scanning line according to the print information is formed on the photoconductive drum 61. Also, since the photoconductive drum 61 rotates in a sub-scanning direction, a plurality of scanning lines are formed in a sub-scanning direction on the photoconductive drum 61. As a result, a two-dimensional latent image corresponding to the print information is formed on the photoconductive drum 61. It should be noted that the reflecting surface of the polygon mirror 44 and the photoconductive drum 61 have a conjugate relationship with respect to the sub-scanning direction. Accordingly, the scanning line spacing is not shifted in a sub-scanning direction, even when the polygon mirror 44 incurs a facet error.

The developing unit 50 includes a developing solution tank 51 in which the developing solution is stored, a pump unit 52 that aspirates the developing solution out of the developing solution tank 51, a measuring roller 53 to which the aspirated developing solution is supplied, an adjusting blade 54 that adjusts an amount of the developing solution supplied to the measuring roller 53, a developing roller 55 that carries the adjusted developing solution, a developing roller charger (hereinafter, referred to as a corona charger) 56 that charges the developing roller 55, and a developing roller cleaning blade 58 the scrapes off the developing solution from the surface of the developing roller 55, for removal. On the surface of the photoconductive drum 61, a latent image is formed by the LSU 40 based on the print information. A photoconductive drum charger (hereinafter, referred to as a corona charger) 62 charges the photoconductive drum 61 for adhering the toner according to the latent image onto the surface of the photoconductive drum 61. The photoconductive drum 61 and the corona charger 62 are located close to the developing unit 50. A photoconductive drum cleaning blade 63 is located close to the developing unit 50, for scraping off the toner remaining on the surface of the photoconductive drum 61 without being transferred to an intermediate transfer roll 71, to be later described, included in the transfer unit 70.

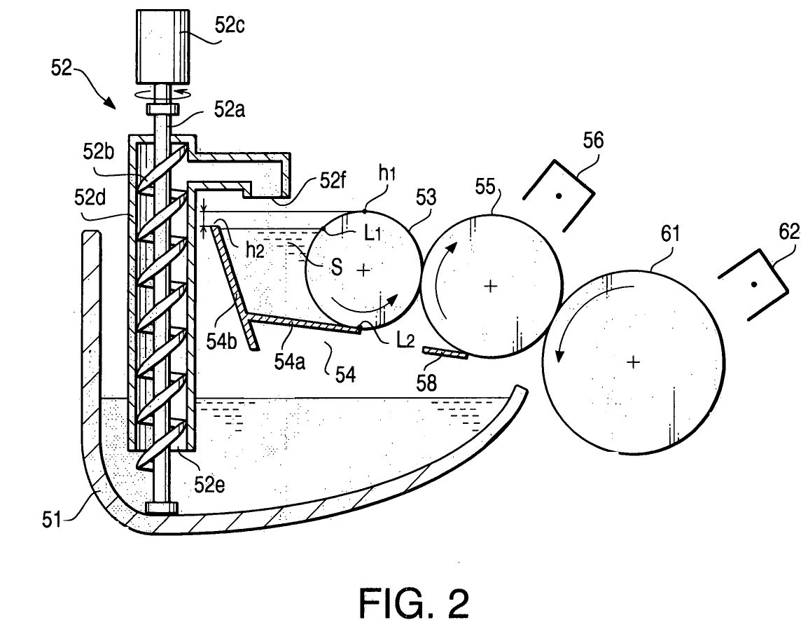

Next, a flow of the developing solution inside the developing unit 50 as well as a developing process performed therein will be described. FIG. 2 is a cross-sectional side view showing a section around the measuring roller 53.

The pump unit 52 includes a rotating shaft 52a extending upward from a bottom portion of the developing solution tank 51, a spiral rotor 52b fixedly disposed around the rotating shaft 52a, a motor 52c that rotates the rotating shaft 52a around its axial center, a housing 52d accommodating therein the spiral rotor 52b and the rotating shaft 52a surrounded by the spiral rotor 52b, an opening 52e provided on the housing 52d at a position close to a bottom portion of the developing solution collection tank, and an opening 52f provided on the housing 52d at a position above the developing solution collection tank. When the control unit 20 drives the motor 52c, the rotating shaft 52a, and hence the spiral rotor 52b are caused to rotate. This rotation causes the developing solution in the developing solution tank 51 to be aspirated through the opening 52e upward into the housing 52d. The developing solution that has been pumped upward is discharged through the opening 52f. It is to be noted that the developing solution stored in the developing solution tank 51 is agitated by an agitating mechanism (not shown), and the temperature of the developing solution is also controlled by a temperature control mechanism, which is not shown either.

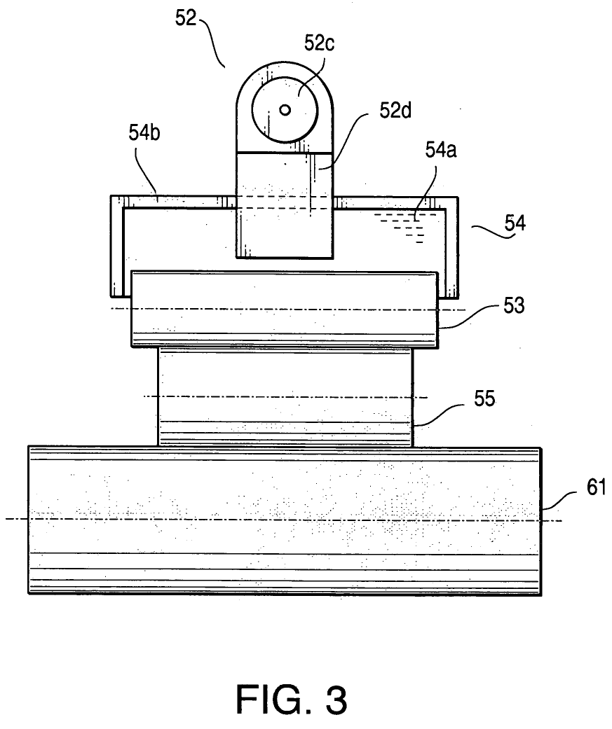

FIG. 3 is a plan view of the wet type printer 100, viewed from an upper direction thereof, showing a section around the measuring roller 53. The measuring roller 53 is provided with a plurality of linear grooves formed at every predetermined interval on its surface, and set to rotate counterclockwise in FIGS. 1 and 2. As shown in FIGS. 2 and 3, the adjusting blade 54 includes a blade portion 54a disposed in contact with the surface of the measuring roller 53 for scraping off the excessive developing solution stuck thereto, and a wall portion 54b integrally formed with the blade portion 54a, so as to enclose the blade portion 54a from three directions.

With this configuration, as shown in FIGS. 2 and 3, the wall portion 54b, the blade portion 54a and a part of the surface of the measuring roller 53 define a developing solution reservoir S. That is, when the measuring roller 53 and the adjusting blade 54 are incorporated in the wet type printer 100, the reservoir S of generally a rectangular parallelepiped shape is formed right under the opening 52f, with the blade portion 54a constituting the bottom face and the wall portion 54b and a part of the surface of the measuring roller 53 constituting the four lateral faces.

The developing solution discharged through the opening 52f drops to the reservoir S, thus to be deposited therein. Accordingly, a portion that is dipped in the developing solution, on the surface of the measuring roller 53, is defined as a region between a line L₁ determined by the surface level of the developing solution and a line L₂ along the interface between the measuring roller 53 and the blade portion 54a.

It is desirable that the wall portion 54b is formed such that an upper most portion h₂ thereof is located lower than an uppermost portion h₁ of the measuring roller 53, to prevent the developing solution deposited in the reservoir S from overflowing beyond the measuring roller 53 and thereby sticking to the developing roller 55 or the photoconductive drum 61. Accordingly, in order to secure a largest possible surface area of the measuring roller 53 that can be dipped in the developing solution, it is preferable to locate the uppermost portion h₂ of the wall portion as close as possible to the uppermost portion h₁ of the measuring roller 53. For such reason the line L₁ is located close to the uppermost position h₁ of the measuring roller 53.

The blade portion 54a is disposed such that the edge portion thereof contacts the surface of the measuring roller 53 at a position lower than the rotating axis of the measuring roller 53. The positions of the blade portion 54a and the measuring roller 53 increase the spacing between the line L₂ and the line L₁, and hence also increase the surface area of the measuring roller 53 that can be dipped in the developing solution. Consequently, the developing solution can be fully supplied in the grooves on the measuring roller 53. Here, disposing the blade portion 54a so as to contact the measuring roller 53 at a position close to the interface between the measuring roller 53 and the developing roller 55 allows further separation of the line L₂ from the line L₁ along the counterclockwise rotating direction, thereby securing a still larger surface area that is dipped in the developing solution, on the measuring roller 53.

Further, forming the adjusting blade 54 so as to include the blade portion 54a and the wall portion 54b eliminates the need to provide an additional component serving to dip the measuring roller 53 in the developing solution, unlike a conventional apparatus. This enables further reduction in dimensions of the apparatus as a whole, as well as in the manufacturing cost.

A portion of the developing solution supplied to the measuring roller 53 out of the reservoir S is scraped off (i.e. adjusted) by the blade portion 54a at the line L₂. On the other hand, another portion of the developing solution supplied to the measuring roller 53 is not scraped off, since such portion is retained in the grooves. Accordingly, it is only the portion of the developing solution retained in the grooves, i.e. the accurately measured portion of the developing solution, that remains on the surface of the measuring roller 53. Such configuration enables achieving uniform application of the developing solution to the developing roller 55, which rotates in contact with the measuring roller 53.

The developing solution contains the toner in a uniform concentration, immediately after the application to the developing roller 55 from the measuring roller 53. Accordingly, the toner is uniformly distributed in the carrier solution, in a region close to the interface between the measuring roller 53 and the developing roller 55. The developing roller 55 rotates in the clockwise direction, according to the orientation of FIGS. 1 and 2. Therefore, the developing solution having a uniform concentration is carried by the surface of the developing roller 55, to thereby pass under the corona charger 56.

The developing roller 55 has a surface constituted of a conductive material, so that such surface is uniformly charged by a corona charging effect of the corona charger 56. The charging effect generates an electric field between the surfaces of the developing roller 55 and the developing solution, thereby causing the toner, which has been uniformly distributed in the carrier solution, to move toward the surface of the developing roller 55 and to closely stick thereto. In other words, the developing solution is split into two layers, namely a layer containing only the carrier solution and the other layer containing the toner in a higher concentration than the initial state in the carrier solution. Obviously it is the latter layer that contacts the surface of the developing roller 55.

The developing solution split into two layers then reaches the position to contact the photoconductive drum 61. On the surface of the photoconductive drum 61, the latent image corresponding to the print information is formed, by the beam emitted from the LSU 40. The photoconductive drum 61 is charged so as to gain a higher potential than that of the developing roller 55, by corona charger 62. However, the region where the latent image is formed gains a lower potential than the developing roller 55, because of an effect of the laser beam. Accordingly, between the region excluding the latent image on the photoconductive drum 61 and the surface of the developing roller 55, the toner remains closely stuck to the lower-potential region, i.e. the surface of the developing roller 55, without being transferred to the region where the latent image is not provided. Consequently, the region excluding the latent image is not developed. By contrast, between the latent image region on the surface of the photoconductive drum 61 and the surface of the developing roller 55, the toner performs electrophoresis toward the lower-potential region, i.e. the latent image region on the surface of the photoconductive drum 61, thus to adhere thereto. That is how the latent image on the photoconductive drum 61 is developed, to turn into a toner image.

The developing solution containing the toner, which has not been utilized in the developing process, is scraped off by the developing roller cleaning blade 58 disposed in contact with the surface of the developing roller 55, and collected into the developing solution tank 51.

The toner image developed on the surface of the photoconductive drum 61 is transferred to the recording paper P by the transfer unit 70. The transfer unit 70 includes an intermediate transfer roll 71, a carrier solution squeeze roll 72, a carrier solution cleaning blade 73, a secondary transfer roll 74, and an intermediate transfer roll cleaning unit 75.

To the intermediate transfer roll 71, a transfer bias of a reverse polarity to the toner is applied, so that the toner image developed on the surface of the photoconductive drum 61 is transferred as a primary step to the intermediate transfer roll 71, at the interface between the photoconductive drum 61 and the intermediate transfer roll 71. At this stage, the portion of the toner remaining on the surface of the photoconductive drum 61 without being transferred at the interface is scraped from the surface, by the photoconductive drum cleaning blade 63. Also, the carrier solution that has adhered to the surface of the intermediate transfer roll 71 together with the toner image is squeezed off from the surface by the carrier solution squeeze roll 72. Such residual carrier solution is then removed from the surface of the carrier solution squeeze roll 72 by the carrier solution cleaning blade 73, and collected in a waste toner box (not shown), to be disposed of as a waste toner.

The intermediate transfer roll 71 and the secondary transfer roll 74 are disposed so as to oppose each other across the paper path for the recording paper P, and mutually butted at a predetermined nip pressure. The toner image transferred to the surface of the intermediate transfer roll 71 is transferred to the recording paper P being carried along the paper path at the interface with the secondary transfer roll 74, by the effect of a transfer electric field, the nip pressure and so on. The intermediate transfer roll 71, interposed between the secondary transfer roll 74 and the photoconductive drum 61, also serves to prevent the nip pressure of the secondary transfer roll 74 from being directly applied to the photoconductive drum 61. Further, the toner that remains on the surface of the intermediate transfer roll 71 after the transference to the recording paper P is removed by the intermediate transfer roll cleaning unit 75, and collected in a waste toner box (not shown), to be disposed of as a waste toner.,

The recording paper P on which the toner image has been transferred is carried to the fixing unit 80 along the paper path 14. The fixing unit 80 serves to apply heat and pressure to the recording paper P, so as to fix the toner image (i.e. the printing information) onto the recording paper P, and includes a heat roller 81 that heats up the recording paper P, and a press roller 82 opposing the heat roller 81 across the paper path, so as to hold the recording paper P in cooperation with the heat roller 81, thus to apply a pressure to the recording paper P. The recording paper P, on which the image according to the printing information has been fixed by the fixing unit 80, is discharged through the paper outlet 15.

Although the present invention has been described based on the foregoing embodiment, it is to be understood that the present invention is not limited thereto, but various modifications may be made without departing the scope and spirit of the present invention.

The present disclosure relates to the subject matter contained in Japanese Patent Application No. 2004-167975, filed on Jun. 7, 2004, which is expressly incorporated herein by reference in its entirety.

1. A wet type electrophotographic image forming apparatus using a developing solution containing a toner in a carrier solution, comprising:
a photoconductive drum on which a latent image is formed;
a developing solution applying roller that applies the developing solution to a surface of the photoconductive drum; and
a blade unit having a blade member disposed in contact with a surface of the developing solution applying roller, the blade scraping off and adjusting the developing solution on the surface of the developing solution applying roller, and a wall portion connected to the blade member such that the blade member, the wall portion and a part of the surface of the developing solution applying roller define a reservoir in which the developing solution is deposited.

2. The wet type image forming apparatus according to claim 1, further comprising:
a developing solution collecting tank in which the developing solution that has been applied on at least one of the developing solution applying roller and the photoconductive drum but has not been consumed is stored; and
a developing solution supplier that supplies the developing solution in the developing solution collecting tank to the reservoir.

3. The wet type image forming apparatus according to claim 1, wherein the developing solution supplier comprises:
a frame including a first opening located in the collection tank developing solution and a second opening located close to the reservoir;
a spiral rotor installed inside the frame, which rotates to forward a fluid entering through the first opening to the second opening; and
a driver that causes the spiral rotor to rotate.

4. The wet type image forming apparatus according to claim 1, wherein the developing solution applying roller and the blade member are in mutual contact at a position lower than a central portion of the developing solution applying roller.

5. The wet type image forming apparatus according to claim 1, wherein the developing solution applying roller and the blade member are in mutual contact at a position close to the interface between the developing solution applying roller and the toner supplier.

6. The wet type image forming apparatus according to claim 1, wherein the blade member is formed such that an uppermost portion thereof is located lower than an uppermost portion of the developing solution applying roller.

7. A wet type electrophotographic image forming apparatus using a developing solution containing a toner in a carrier solution, comprising:
a photoconductive drum on which a latent image is formed;
a developing solution applying roller that applies the developing solution to a surface of the photoconductive drum; and
a developing solution reservoir in which the developing solution is deposited,
wherein a part of a surface of the developing solution applying roller serves as a wall portion defining the reservoir, and
wherein a bottom surface of the reservoir serves as a blade member that contacts a surface of the developing solution applying roller to scrape off and adjust the developing solution on the surface of the developing solution applying roller.
